(19) United States
(12) Patent Application Publication
(10) Pub. No.: US 2025/0139660 A1
(43) Pub. Date: May 1, 2025

(54) METHOD, APPARATUS, DEVICE AND MEDIUM FOR DETERMINING QUANTITY OF REQUISITE RESOURCES FOR PLACEMENT OF MEDIA ITEM

(71) Applicants: Beijing Youzhuju Network technology Co., Ltd., Beijing (CN); Lemon Inc., Grand Cayman (KY)

(72) Inventors: Qingliang CAI, Beijing (CN); Bo ZHENG, Beijing (CN); Zhe WANG, Los Angeles, CA (US)

(21) Appl. No.: 18/932,325

(22) Filed: Oct. 30, 2024

(30) Foreign Application Priority Data
Oct. 30, 2023 (CN) 202311424290.8

(51) Int. Cl. G06Q 30/0242; G06Q 30/0273

(52) U.S. Cl. CPC G06Q 30/0242; G06Q 30/0275

(57) ABSTRACT

A method, apparatus, device and medium for determining quantity of requisite resources for placing a media item are provided. In the method, feature information of a target media item is extracted from relevant data of the target media item. Predicted values of quantity of requisite resources for a plurality of placements in competitive placement of the target media item are obtained using a prediction model based at least on the feature information, the predicted values of the quantity of requisite resources for the plurality of placements respectively corresponding to a plurality of predetermined probabilities of the target media item being placed. Quantity of requisite resources for placing the target media item is determined from the predicted values of the quantity of requisite resources for the plurality of placements, based on a plurality of placement efficiency measures associated with the predicted values of the quantity of requisite resources.

### CROSS-REFERENCE

The present application claims priority to Chinese Patent Application No. 2023114242908, filed on Oct. 30, 2023, and entitled “METHOD, APPARATUS, DEVICE AND MEDIUM FOR DETERMINING QUANTITY OF REQUISITE RESOURCES FOR PLACEMENT OF MEDIA ITEM”, the entirety of which is incorporated herein by reference.

### FIELD

Example implementations of the present disclosure generally relate to the field of computer technologies, and in particular, to a method, apparatus, device, and computer-readable storage medium for determining quantity of requisite resources for placement of a media item.

### BACKGROUND

The Internet provides access to a wide variety of objects. For example, data such as various applications, commodities, audio, video and the like may be accessed through the Internet. In addition, accessible data also includes specific media items related to the items, including, for example, advertisements. Object providers with objects may provide the placement of media items to media placement parties. The placement of the media item may be contention-based. Whether a media item can be placed successfully depends on the quantity of requisite resources for placement of the media item, which is also referred to as a bid.

### SUMMARY

In a first aspect of the present disclosure, a method for determining quantity of requisite resources for placing a media item is provided. In the method, feature information of a target media item is extracted from relevant data of the target media item. Predicted values of quantity of requisite resources for a plurality of placements in competitive placement of the target media item are obtained using a prediction model based at least on the feature information, the predicted values of the quantity of requisite resources for the plurality of placements respectively corresponding to a plurality of predetermined probabilities of the target media item being placed. Quantity of requisite resources for placing the target media item is determined from the predicted values of the quantity of requisite resources for the plurality of placements, based on a plurality of placement efficiency measures associated with the predicted values of the quantity of requisite resources for the plurality of placements.

In a second aspect of the present disclosure, an apparatus for determining quantity of requisite resources for placing a media item is provided. The apparatus comprises: an extracting module configured to extract feature information of a target media item from relevant data of the target media item; an obtaining module configured to obtain, using a prediction model, predicted values of quantity of requisite resources for a plurality of placements in competitive placement of the target media item based at least on the feature information, the predicted values of the quantity of requisite resources for the plurality of placements respectively corresponding to a plurality of predetermined probabilities of the target media item being placed; and a determining module configured to determine, from the predicted values of the quantity of requisite resources for the plurality of placements, quantity of requisite resources for placing the target media item, based on a plurality of placement efficiency measures associated with the predicted values of the quantity of requisite resources for the plurality of placements.

In a third aspect of the present disclosure, an electronic device is provided. The electronic device comprises: at least one processing unit; and at least one memory, coupled to the at least one processing unit and storing instructions executed by the at least one processing unit, the instructions, when executed by the at least one processing unit, causing the electronic device to perform the method according to the first aspect of the present disclosure.

In a fourth aspect of the present disclosure, a computer-readable storage medium is provided, storing a computer program thereon, the computer program, when executed by a processor, causing the processor to implement the method according to the first aspect of the present disclosure.

It should be understood that what is described in this Summary is not intended to identify key features or essential features of the implementations of the present disclosure, nor is it intended to limit the scope of the present disclosure. Other features disclosed herein will become easily understandable through the following description.

### BRIEF DESCRIPTION OF THE DRAWINGS

The above and other features, advantages, and aspects of respective implementations of the present disclosure will become more apparent from the following detailed description with reference to the accompanying drawings. The same or similar reference numerals represent the same or similar elements throughout the figures, where:

FIG. 1 illustrates a block diagram of an environment for placement of a media item according to an example implementation of the present disclosure;

FIG. 2 illustrates a block diagram of determining quantity of requisite resources for placing a media item according to some implementations of the present disclosure;

FIG. 3 shows a block diagram of feature information of a media item according to some implementations of the present disclosure;

FIG. 4 illustrates a block diagram of a relationship between a prediction model and a plurality of predetermined probabilities according to some implementations of the present disclosure;

FIG. 5 shows a block diagram of a prediction model according to some implementations of the present disclosure;

FIG. 6 shows a flowchart of a method for determining quantity of requisite resources for placing a media item according to some implementations of the present disclosure;

FIG. 7 illustrates a block diagram of an apparatus for determining quantity of requisite resources for placing a media item according to some implementations of the present disclosure; and

FIG. 8 illustrates a block diagram of a device capable of implementing various implementations of the present disclosure.

### DETAILED DESCRIPTION

The implementations of the present disclosure will be described in more detail with reference to the accompanying drawings, in which some implementations of the present disclosure have been illustrated. However, it should be understood that the present disclosure can be implemented in various manners, and thus should not be construed to be limited to implementations disclosed herein. On the contrary, those implementations are provided for the thorough and complete understanding of the present disclosure. It should be understood that the drawings and implementations of the present disclosure are only used for illustration, rather than limiting the protection scope of the present disclosure.

As used herein, the term “comprise” and its variants are to be read as open terms that mean “include, but is not limited to.” The term “based on” is to be read as “based at least in part on.” The term “one implementation” or “the implementation” is to be read as “at least one implementation.” The term “some implementations” is to be read as “at least some implementations.” Other definitions, explicit and implicit, might be further included below. As used herein, the term “model” may represent associations between respective data. For example, the above association may be obtained based on various technical solutions that are currently known and/or to be developed in future.

It is to be understood that the data involved in this technical solution (including but not limited to the data itself, data acquisition or use) should comply with the requirements of corresponding laws and regulations and relevant provisions.

It is to be understood that, before applying the technical solutions disclosed in respective embodiments of the present disclosure, the user should be informed of the type, scope of use, and use scenario of the personal information involved in the present disclosure in an appropriate manner in accordance with relevant laws and regulations, and user authorization should be obtained.

For example, in response to receiving an active request from the user, prompt information is sent to the user to explicitly inform the user that the requested operation would acquire and use the user's personal information. Therefore, according to the prompt information, the user may decide on his/her own whether to provide the personal information to the software or hardware, such as electronic devices, applications, servers, or storage media that perform operations of the technical solutions of the present disclosure.

As an optional but non-limiting implementation, in response to receiving an active request from the user, the way of sending the prompt information to the user may, for example, include a pop-up window, and the prompt information may be presented in the form of text in the pop-up window. In addition, the pop-up window may also carry a select control for the user to choose to “agree” or “disagree” to provide the personal information to the electronic device.

It is to be understood that the above process of notifying and obtaining the user authorization is only illustrative and does not limit the implementations of the present disclosure. Other methods that satisfy relevant laws and regulations are also applicable to the implementations of the present disclosure.

As used herein, the term “in response to” indicates a state in which a corresponding event occurs or a condition is satisfied. It is to be understood that the timing of the execution of a subsequent action that is performed in response to the event or condition is not necessarily strongly correlated to the time at which the event or condition occurs or is established. For example, in some cases, the subsequent action may be performed immediately upon occurrence of the event or upon satisfaction of the condition. In other cases, the subsequent action may be performed only after a period of time since the event occurs or the condition is established.

### Example Environment

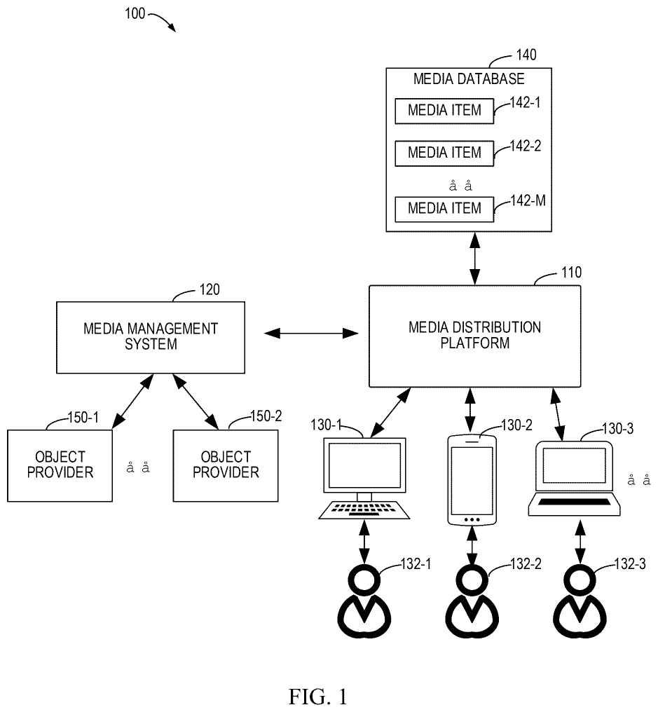

Referring to FIG. 1, a summary is described according to an example implementation of the present disclosure. FIG. 1 shows a block diagram of an environment 100 for media item placement according to an example implementation of the present disclosure. As shown in FIG. 1, one or more media providers may use a media management system 120 to manage media to be provided on a media distribution platform 110. One or more terminal devices 130-1, 130-2, 130-3 and the like (collectively or individually referred to as terminal devices 130 for ease of discussion) are associated with the media distribution platform 110 and may access various types of media provided on the media distribution platform 110, e.g., based on respective audiences 132-1, 132-2, 132-3 and the like (collectively or individually referred to as audiences 132 for ease of discussion). As an example, the media distribution platform 110 may be an application, a website, a web page, and other accessible platforms. The terminal device 130 may be installed with an application for accessing the media distribution platform 110, or may access the media distribution platform 110 in a suitable manner.

The media management system 120 may be configured to place one or more specific media items (e.g., provided or presented at the terminal device 130) related to the one or more object to the audience population based on a corresponding policy. The media items to be placed may include, for example, one or more media items 142-1, 142-2, . . . 142-M (collectively or individually referred to as media items 132 for ease of discussion).

Herein, the object may include, for example, various recommendable recommendation items, examples of which may include an application, a physical commodity, a virtual commodity, an audio and video media, and the like. Herein, a media item refers to a media that is presented in order to recommend a corresponding object. Examples of media items may include advertisements. As used herein, an audience population may include one or more audience members, such as the audiences 132. An audience member may be any potential consumer of an object, such as a user, group, organization, entity, or the like.

In some implementations, the media management system 120 may distribute corresponding media items on the media distribution platform 110 based on requests of object providers 150-1, 150-2, 150-3, etc. (collectively or individually referred to as object providers 150 for ease of discussion). In some implementations, the media management system 120 may place the media items 142 to the corresponding audiences 132 on the media distribution platform 110 based at least on requests from the respective object providers 150-1, 150-2, 150-3, etc. (collectively or individually referred to as object providers 150 for ease of discussion). In the context of advertisement placement, the object provider 150 is sometimes also referred to as an advertiser. In some implementations, the object provider may also pay the media provider based on the presentation of the media item and subsequent conversions, etc.

In some implementations, the media management system 120 may select media items to be presented to a particular terminal device 130 in a media placement opportunity (e.g., at a particular time and a particular location) of the media distribution platform 110 based on bid results. For example, the media management system 120 may receive a bid from the object provider 150. In some implementations, the media management system 120 may assign the media placement opportunity to the highest bidder, meaning that the corresponding media item may be successfully placed in the competitive placement. The bid may refer to the quantity of requisite resources to be spent in contending for placement of a certain media item in a certain media placement opportunity. That the media item is successfully placed at a cost is referred to as a sending, and the cost is referred to as a bid for the present placement or sending.

In the environment 100, the terminal device 110 may be any type of mobile terminal, fixed terminal, or portable terminal, including a mobile phone, desktop computer, laptop computer, notebook computer, netbook computer, tablet computer, media computer, multimedia tablet, personal communication system (PCS) device, personal navigation device, personal digital assistant (PDA), audio/video player, digital camera/camcorder, positioning device, television receiver, radio broadcast receiver, electronic book device, gaming device, or any combination of the foregoing, including accessories and peripherals of these devices, or any combination thereof. In some implementations, the terminal device 110 can also support any type of interface for a user (such as a “wearable” circuit, etc.). The media management system 120 may be, for example, various types of computing systems/servers capable of providing computing power, including, but not limited to, mainframes, edge computing nodes, computing devices in a cloud environment, and the like. It should be understood that the structures and functions of the various elements in the environment 100 are described for illustrative purposes only and do not imply any limitation to the scope of the present disclosure.

In the competitive placement, the plurality of object providers 150 may give the quantity of requisite resources for the placement of the respective media items, that is, the plurality of object providers 150 may bid on the quantity of requisite resources for placement. The media management system 120 may select, for example, the highest bid from the various bids and place relevant media items 142 of the object provider 150 in the media distribution platform 110. While increasing bids may improve the likelihood of winning the bidding, excessive bids may increase the burden on the object provider 150. Too low bids may cause the object provider to lose the opportunity to present media items. In this case, it is desirable to determine the quantity of requisite resources for placement in a more reasonable manner and further bid according to the quantity of requisite resources for placement.

### Summary of Determining the Quantity of Requisite Resources for Placement

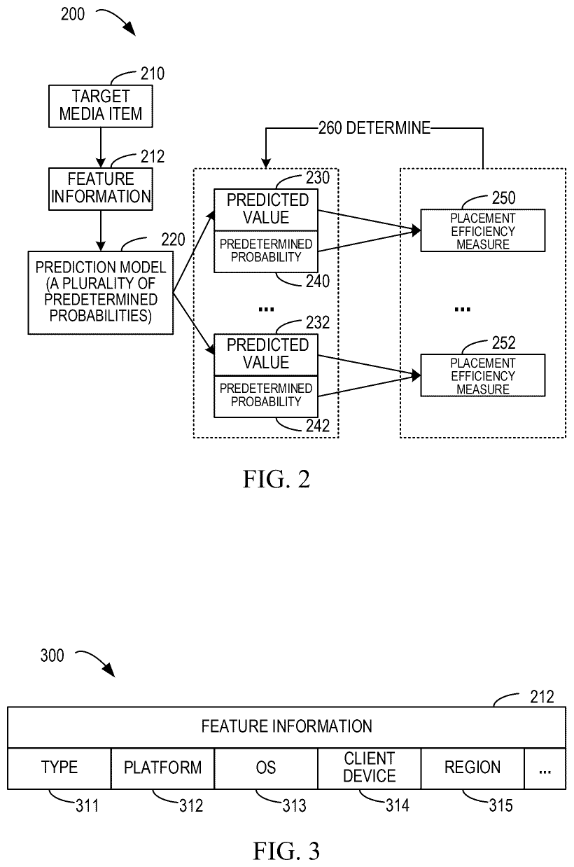

In order to at least partially solve the deficiencies in the prior art, according to an example implementation of the present disclosure, a method for determining the quantity of requisite resources for placement of a media item is provided. Referring to FIG. 2, a summary is described according to an example implementation of the present disclosure. FIG. 2 shows a block diagram 200 of determining the quantity of requisite resources for placement of a media item according to some implementations of the present disclosure. The process of determining the quantity of requisite resources for placement of a target media item 210 is shown in FIG. 2. The target media item 210 is to be placed to recommend a target object indicated in the target media item 210. For example, the target media item 210 may be an advertisement for promoting given application software, etc.

Specifically, feature information 212 of the target media item 210 may be extracted from various related data of the target media item 210. According to an example implementation of the present disclosure, a prediction model 220 may be pre-constructed, and predicted values of the quantity of requisite resources for a plurality of placements in competitive placement of the target media item 210 may be determined using the prediction model 220 based at least on the feature information 212. Here, the predicted values of the quantity of requisite resources for a plurality of placements as output by the prediction model 220 may respectively correspond to a plurality of predetermined probabilities of the target media item 210 being successfully placed.

Here, the prediction model 220 may provide predicted values of the quantity of requisite resources for placement associated with the plurality of (e.g., denoted as n) predetermined probabilities. The plurality of prediction probabilities may be represented as, for example, F₁(i), where 0≤i≤n-1, and the predicted value of the quantity of requisite resources for a plurality of corresponding placements may be represented as, for example, B₁(i), where 0≤i≤n-1. At this point, i indicates the i-th position, F₁(i) may represent the i-th predetermined probability, and B₁(i) may represent the predicted value of the quantity of requisite resources for placement corresponding to the i predetermined probability. For example, the plurality of predetermined probabilities may be represented in a quantile manner, for example, a predetermined probability 240 may indicate that the winning probability of bidding according to a corresponding predicted value 230 is 5%, . . . , and a predetermined probability 242 may indicate that the winning probability of bidding according to a corresponding predicted value 232 is 95%, etc.

Further, the quantity of requisite resources for placement of the target media item may be determined 260 from the predicted values of the quantity of requisite resources for placement based on a plurality of placement efficiency measures 250, . . . , and 252 respectively associated with the predicted values of the quantity of requisite resources for placement. Here, the placement efficiency measure may, for example, represent the profit that can be generated by placing the target media item, and the predicted value corresponding to the highest or higher placement efficiency measure may be selected from the predicted values of the quantity of requisite resources for placement as the final quantity of requisite resources for placement (i.e., the bid). In this way, the placement efficiency of the media item can be improved, for example, the influence of the target media item can be broadened and more audiences can browse the placed media item.

### Detailed Process for Determining the Quantity of Requisite Resources for Placement

Having described the summary according to one example implementation of the present disclosure, more details of determining the quantity of requisite resources for placement of a target media item will be described in detail below. In the context of the present disclosure, historical data in the historical placement process may be used as a basis to generate a prediction model. It should be understood that, although the media items involved in each historical placement process are not completely the same, they might have some common features, and thus may be used as a basis in terms of common features, thereby facilitating the extraction of the general basis of determining the quantity of requisite resources for placement of the media item.

As used herein, the term “model” may learn an association relationship between respective inputs and outputs from training data such that a corresponding output may be generated for a given input after training is completed. The model may be generated based on machine learning techniques. Deep learning is a machine learning algorithm that processes inputs and provides corresponding outputs by using a multi-layer processing unit. The neural network model is one example of a deep learning based model. As used herein, a “model” may also be referred to as a “machine learning model.” a “learning model.” a “machine learning network.” or a “learning network.” which may be used interchangeably herein.

A “neural network” is a deep learning-based machine learning network. The neural network is capable of processing inputs and providing respective outputs, which typically include an input layer and an output layer and one or more hidden layers between the input layer and the output layer. Neural networks used in deep learning applications typically include many hidden layers, thereby increasing the depth of the network. Respective layers of the neural network are connected in sequence such that the output of the previous layer is provided as an input to the next layer, where the input layer receives the input of the neural network and the output of the output layer serves as the final output of the neural network. Each layer of the neural network includes one or more nodes (also referred to as processing nodes or neurons), each node processing input from the previous layer.

Generally, machine learning may generally include three phases, a training phase, a testing phase, and an application phase (also referred to as an inference phase). At the training phase, a given model may be trained using a large amount of training data, and parameter values are iteratively updated until the model can obtain consistent inferences from the training data that satisfy the expected objectives. By training, the model may be considered to be able to learn from the training data an association (which may also be referred to as an input-to-output mapping) between an input and an output from the training data. Parameter values of the trained model are determined. In the testing phase, a test input is applied to the trained model to test whether the model can provide a correct output, thereby determining performance of the model. The testing phase may sometimes be integrated in the training phase. In the application phase, the trained model may be used to process the actual model input based on the parameter value obtained by training, to determine a corresponding model output.

According to one example implementation of the present disclosure, the target media item 210 may have relevant data and may extract the feature information 212 from these relevant data. For example, the feature information 212 may include at least one of: a type of the target media item, a platform on which the target media item is to be placed, an operating system of a platform on which the target media item is to be placed, a client device of a platform on which the target media item is to be placed, and a region in which the target media item is to be placed.

FIG. 3 illustrates a block diagram 300 of the feature information 212 of a media item according to some implementations of the present disclosure. As shown in FIG. 3, a type 311 may represent a type of the target media item, for example, may include, but is not limited to, an application, a commodity, audio, video, and the like. A platform 312 may represent a platform on which the target media item is to be placed, for example, may include, but is not limited to, a social network platform, a news push platform, a music platform, a video platform, a short video platform, a game platform, and the like. An operating system 313 may represent an operating system of a platform on which the target media item is to be placed, for example, may include an Android system, an IOS system, and various operating systems of a desktop computer, and the like. A client device 314 may represent a client device of a platform on which the target media item is to be placed, for example, including but not limited to, a desktop device, a mobile device, or the like. A region 315 may represent a region in which the target media item is to be placed, e.g., region I, region II, etc.

With the example implementations of the present disclosure, the feature information 212 may describe various aspects of the target media item 210 in detail, so that various information associated with different placement scenarios may be conveniently represented and the accuracy of the prediction model 220 may be improved. Here, for example, the feature information 212 may be represented in an embedding manner, and the feature information 212 is an encoded form that is invisible to the outside, so that the potential sensitive information is not exposed.

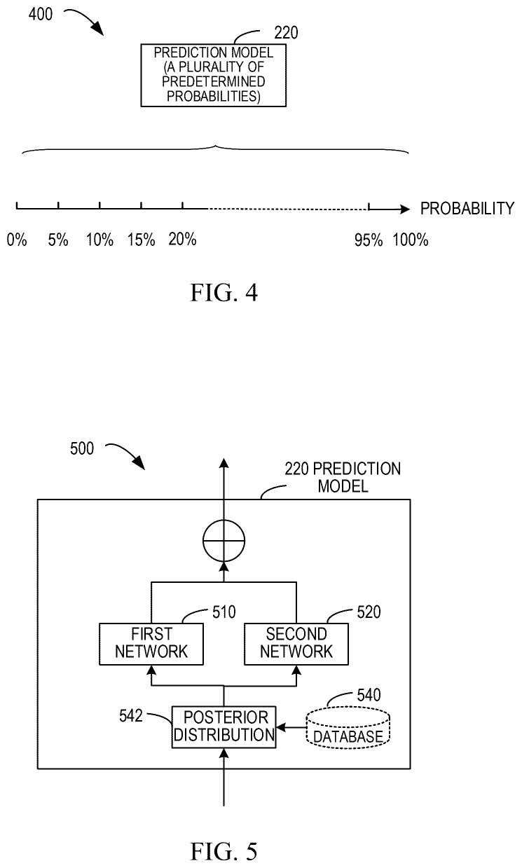

According to an example implementation of the present disclosure, the feature information 212 may be used as an input to the prediction model 220, to determine predicted values of the quantity of requisite resources for a plurality of placements corresponding to a plurality of predetermined probabilities, respectively. Referring to FIG. 4, more details of the prediction model 220 are described, which shows a block diagram 400 of a relationship between a prediction model and a plurality of predetermined probabilities according to some implementations of the present disclosure.

As shown in FIG. 4, the abscissa represents a plurality of probabilities that win in competitive placement, and the plurality of predetermined probabilities of the prediction model 220 may be represented in quantile form, for example. Merely by way of example, the quantile may be determined at intervals of 5% (or other intervals), at which point the plurality of predetermined probabilities may be represented, for example, as 5%, 10%, 15%, 20%, . . . , 95%, etc. Alternatively and/or additionally, the quantile may be determined at intervals of 10%, at which point the plurality of predetermined probabilities may be denoted as 10%, 20%, . . . , 90%, etc. The smaller the interval, the higher the precision represented by the prediction model 220, however the amount of computation involved will increase. According to an example implementation of the present disclosure, a balance may be stricken between the precision and the amount of computation, thereby determining an appropriate interval.

According to an example implementation of the present disclosure, in the process of determining the predicted values of the quantity of requisite resources for a plurality of placements, a distribution of the quantity of requisite resources for a plurality of placements associated with the plurality of predetermined probabilities may be determined using the prediction model 220 based at least on the feature information 212. Continuing with the example above, where the prediction model 220 involves n predetermined probabilities, the distribution may be represented in an n-dimensional array. For example, the distribution associated with the quantity of requisite resources for a plurality of placements may be represented using Value₁= (v₁(0), v₁(1), . . . , v₁(i) . . . , v₁(n-1)), where v₁(i) may represent a specific coefficient corresponding to a certain probability of the distribution. Specifically, the distribution of the quantity of requisite resources for placement may be expressed as Value₁=(0.21,0.43,0.65, . . . ), at which point 0.21 represents a coefficient corresponding to the 5% probability, 0.43 represents a coefficient corresponding to the 10% probability, 0.65 represents a coefficient corresponding to the 15% probability, and the like.

With the example implementations of the present disclosure, the association relationship between the quantity of requisite resources for respective placements and the corresponding winning probability may be described in an accurate and effective manner, thereby improving the accuracy of the prediction model. Further, the predicted values of the quantity of requisite resources for a plurality of placements may be determined based on the distribution of the quantity of requisite resources for a plurality of placements.

It should be understood that the distribution of the quantity of requisite resources for placement herein may be obtained based on historical data in a historical placement process. It should be understood that the historical data may include different scenarios, at which point the foregoing distribution may be determined based on different scenarios. According to an example implementation of the present disclosure, relevant bidding data in some historical placements may be obtained. For example, some media management systems 120 may receive multiple bids from multiple object providers, respectively, at which point the highest bid will win, and media management system 120 will place the highest bidder's media item on the media distribution platform 110.

In one scenario, the media management system 120 will return bidding data (e.g., minimum winning bid) to various object providers. At this point, this scenario may be referred to as a “return scenario”, and the minbid may represent an objective bidding form. When the object provider wins, minbid represents the second highest price in the bids of all the object providers; when the object provider fails, minbid represents the winning bid. In the case that the returned bidding data may be obtained, the distribution of the quantity of requisite resources for placement may be obtained using these historical bidding data.

In another scenario, the media management system 120 does not return bidding data to various object providers. In this case, this scenario may be referred to as “no return scenario”. In the case where minbid is not returned, only the data related to the Send-Show Rate (SSR) of the media item can be obtained. Here, the SSR data represents the rate of the media item to be shown. However, the actual showing process of the media item is: Send-Win-Show. However, the SSR data cannot represent the impact of the bidding process, and thus may be affected by the bidding policy and deviates. At this point, the influence of the bidding process needs to be considered, thereby eliminating the potential deviation in the SSR data.

According to an example implementation of the present disclosure, the proposed prediction model 220 may take into comprehensive consideration two scenarios with return and no return described above, thereby implementing a deviation correction method for a prediction model based on a minbid posterior bidding form. In this way, minbid information in other similar situations can also be used in the no-return scenario to better predict the quantity of requisite resources for placement. Therefore, an accurate estimation of a bidding form can be obtained even in a non-return scenario.

FIG. 5 shows a block diagram 500 of a prediction model according to some implementations of the present disclosure. As shown in FIG. 5, the prediction model 220 may receive the feature data 212 of the target media item 210, and may obtain a posterior distribution 542 associated with the feature data 212 from a database 540 for storing historical bidding data. Further, the feature data and the corresponding posterior distribution 542 may be processed using a first network 510 and a second network 520 to determine a specific distribution associated with the plurality of predetermined probabilities.

It should be understood that although FIG. 5 shows that the database 540 for storing historical data is located inside the prediction model 220, alternatively and/or additionally, the database 540 may be located outside the prediction model 220, for example, located at any location accessible to the prediction model 220, as long as the posterior distribution 542 of the historical bidding data can be obtained from the database 540.

According to an example implementation of the present disclosure, the prediction model 220 may include a first network 510, and the first network 510 may describe a correlation between the posterior distribution 542 of the quantity of requisite resources for relevant placement at each predetermined probability of winning and the feature of the media item in the historical bidding. In other words, the first network 510 may describe a first correlation between a first reference quantity of requisite resources for placement (i.e., historical offer) in a first reference competitive placement (i.e., historical bidding) of a first reference media item (i.e., historical media item) and first reference feature information (i.e., feature of the historical media item) of the first reference media item.

According to an example implementation of the present disclosure, in the process of determining the distribution of the quantity of requisite resources for a plurality of placements associated with the plurality of predetermined probabilities, a first distribution of the quantity of requisite resources for a plurality of placements associated with the plurality of predetermined probabilities may be determined using the first network 510. In this way, the posterior distribution of the real historical bidding data may be fully considered in the prediction model 220, so that the potential prediction deviation is corrected using the distribution trend of the real bidding data.

According to an example implementation of the present disclosure, the correlation may be determined based on a statistical manner, for example, the distribution of the quantity of requisite resources for respective placements corresponding to respective winning probabilities may be obtained from a large amount of historical bidding data based on a statistical manner. Alternatively and/or additionally, the correlation described above may be represented based on a machine learning model. Where the correlation has been obtained, the distribution of the quantity of requisite resources for the statistics-based placement (also referred to as the first distribution) may be determined by the feature data of the target media item.

Assuming that the feature information of the target media item is (application, social network platform, Android system, mobile device, region I), Value₁=(0.21,0.43,0.65, . . . ) may be obtained. Alternatively and/or additionally, when the historical bidding data in the database 540 is different or the feature data of the target media item is different, the distribution of the quantity of requisite resources for placement have other values. For another example, assuming that the feature information of the target media item is (commodity, social network platform, IOS system, mobile device, region II), it may be obtained Value₁= (0.20,0.45,0.60, . . . ), etc.

According to an example implementation of the present disclosure, the predicted value of the quantity of requisite resources for placement at different quantiles may be determined based on the posterior distribution. Specifically, in an advertisement scenario, an ecpm (Expected Cost Per Mile) is usually used as the value measure of the target media item. For example, ecpm the target media item may be calculated according to the following formula:

$$ecpm = cpa\_bid * eptr * ecvr \qquad Formula 1$$

In the above formula, ecpm represents the value measure of the target media item, cpa_bid represents the bid of the object provider for the target media item, eptr represents the estimated value of the click rate of the target media item, and ecvr represents the estimated value of the conversion rate of the target media item.

In the context of the present disclosure, a bid from an object supplier cpa_bid may be received, and the bid may be offered in a bidding manner in one or more third-party media distribution platforms according to the predicted value (e.g., represented as bid_price) of the quantity of requisite resources for placement. In this way, the exposure rate of the media item can be increased, thereby expanding the influence of the media item. In this case, it is expected that the relationship between the predicted value of the quantity of requisite resources for placement and the value measure of the target media item meets a predetermined constraint tac. In the context of the present disclosure, the constraint tac may be represented, for example, by a predetermined percentage (generally, tac <1). For example, the predicted value of the quantity of requisite resources for placement may be limited based on the following formula:

$$bid\_price / ecpm < tac \qquad Formula 2$$

It will be appreciated that for a particular media item, the percentage may be greater than or equal to 1, whereas for a plurality of media items, the overall percentage is typically less than 1. With the example implementations of the present disclosure, the quantity of requisite resources for placement of the media item may be controlled under the specified constraint, thereby achieving the goal of controlling various consumption related to the placement as a whole.

According to an example implementation of the present disclosure, it is assumed that the distribution of the quantity of requisite resources for placement associated with the respective predetermined probabilities is: Value₁=(v₁(0), v₁(1), . . . , v₁(i) . . . , v₁(n-1)). In this case, the predicted value B₁(i) of the quantity of requisite resources for placement associated with the predetermined probability F₁(i) may be represented in the following manner:

$${B}_{1} ( i ) = {v}_{1} ( i ) * ecpm \qquad Formula 3$$

In the above formula, B₁(i) represents the predicted value of the quantity of requisite resources for placement associated with the i-th predetermined probability F₁(i) determined based on the posterior distribution, v₁(i) represents the coefficient of the distribution associated with the i-th predetermined probability F₁(i), and ecpm represents the value measure of the target media item. In this case, where Value₁=(0.21,0.43,0.65, . . . ), the predicted value of the quantity of requisite resources for placement associated with each prediction probability may be determined as:

$${B}_{1} = ( 0.21 * ecpm , 0.43 * ecpm , 0.65 * ecpm , … ) \qquad Formula 4$$

The above formula indicates that when a bid is offered to the third-party media distribution platform with the predicted value B₁(0)=0.21*ecpm of the quantity of requisite resources for placement, the winning probability is 5%; when a bid is offered with the predicted value B₁(1)=0.43*ecpm of the quantity of requisite resources for placement, the winning probability is 10%; when a bid is offered with the predicted value B₁(2)=0.65*ecpm of the quantity of requisite resources for placement, the winning probability is 15%, and so on. In this way, the predicted value of the quantity of requisite resources for respective placements associated with respective winning probabilities may be determined using the first network 510 and based on the posterior statistics.

According to one example implementation of the present disclosure, the prediction model 220 may include a second network 520, which may represent relevant knowledge extracted from the true SSRs in historical placement. Specifically, the second network 520 may describe a second correlation between a show (i.e., historical SSR data) of a second reference media item (i.e., historical media item) in a second reference competitive placement (i.e., historical bidding) of the second reference media item and second reference feature information (i.e., feature of the historical media item) of the second reference media item.

Here, the second network 520 may be trained based on the historical truth data. In particular, an initial parameter of the second network 520 may be obtained, and the above parameter may be updated in several ways that are now known and/or to be developed in the future in order to minimize the difference between an output result of the second network 520 and the corresponding truth data. Further, on the basis that the second network 520 has been obtained, a second distribution of the quantity of requisite resources for a plurality of placements associated with the plurality of predetermined probabilities may be determined using the second network 520, respectively. According to the example implementation manner of the present disclosure, multi-aspect knowledge about the placement of the media item may be extracted from the truth show data in the historical placement process, thereby facilitating the subsequent bidding process.

Like the various operational steps of the first network 510 described above, the second distribution of the quantity of requisite resources for a plurality of placements associated with the plurality of predetermined probabilities determined based on the SSR data may be determined.

$${Value}_{2} = ( {v}_{2} ( 0 ) , {v}_{2} ( 1 ) , … , {v}_{2} ( i ) … , {v}_{2} ( n - 1 ) ) \qquad Formula 5$$

In the above formula, Value₂ represents the second distribution of the quantity of requisite resources for a plurality of placements associated with the respective predetermined probabilities, and v₂(i) represents the distribution coefficient associated with the i-th predetermined probability. Here, the respective predetermined probabilities are consistent with what is shown in FIG. 4 (i.e., F₁(i)=F₂(i)=F (i)), and may be represented by quantiles 5%, 10%, 15%, etc. Further, the predicted values of the quantity of requisite resources for placement associated with respective predetermined probabilities determined based on the SSR data may be determined.

$${B}_{2} ( i ) = {v}_{2} ( i ) * ecpm \qquad Formula 6$$

In the above formula, B₂(i) represents the predicted value of the quantity of requisite resources for placement associated with the i-th predetermined probability determined based on the second network 520. According to one example implementation of the present disclosure, Value₁ and Value₂ usually have different values. In this case, where Value₂=(0.20,0.40,0.60, . . . ), the predicted value of the quantity of requisite resources for placement associated with each prediction probability may be determined based on the second network 520 as:

$${B}_{2} = ( 0.2 * ecpm , 0.4 * ecpm , 0.6 * ecpm , … ) \qquad Formula 7$$

The above formula indicates that when a bid is offered to the third-party media distribution platform with the predicted value B₂(0)=0.20*ecpm of the quantity of requisite resources for placement, the show probability is 5%; when a bid is offered to the third-party media distribution platform with the predicted value B₂(1)=0.40*ecpm of the quantity of requisite resources for placement, the show probability is 10%; when a bid is offered to the third-party media distribution platform with the predicted value B₂(2)=0.60*ecpm of the quantity of requisite resources for placement, the show probability is 15%, and so on.

According to an example implementation of the present disclosure, the plurality of placement efficiency measures are determined based on the predicted values of the quantity of requisite resources for a plurality of placements, a value measure of the target media item, and the plurality of predetermined probabilities. Specifically, the plurality of placement efficiency measures may be determined based on the following formula:

$${profit}_{1} ( i ) = [ Ctr * C - {B}_{1} ( i ) ] * {F}_{1} ( i ) \qquad Formula 8.1$$

$${profit}_{2} ( i ) = [ Ctr * C - {B}_{2} ( i ) ] * {F}_{2} ( i ) \qquad Formula 8.2$$

In the above formula, profit₁(i) represents the placement efficiency measure (i.e., profit) associated with the i-th predetermined probability F₁(i) determined based on the posterior distribution, and B₁ represents the predicted value of the quantity of requisite resources for placement associated with the i-th predetermined probability F (i) determined based on the posterior distribution, profit₂ (i) represents the placement efficiency measure associated with the i-th predetermined probability F₁(i) determined based on the SSR data, and B₂ represents the predicted value of the quantity of requisite resources for placement associated with the i-th predetermined probability F (i) determined based on the SSR data. Ctr represents a predetermined control parameter, and C represents a value measure ecpm determined for the target media item.

With the example implementations of the present disclosure, the complex steps of determining the placement efficiency measure may be converted into a simple mathematical operation process. In this way, the placement efficiency measure that may result from bidding at various predetermined probabilities may be determined in a simpler and more effective manner based on mathematical operations.

According to an example implementation of the present disclosure, the control parameter in the above formula may be determined in various manners. For example, the control parameter may be determined based on a proportional integral differential (PID) technique, thereby adjusting a plurality of placement efficiency measures. The control parameter may be set based on a general principle of the PID control algorithm, at which point a plurality of placement efficiency measures may be determined based on the following formula:

$${profit}_{1} ( i ) = [ ( K + \frac{1}{λ} ) * C - {B}_{1} ( i ) ] * {F}_{1} ( i ) \qquad Formula 9.1$$

$${profit}_{2} ( i ) = [ ( K + \frac{1}{λ} ) * C - {B}_{2} ( i ) ] * {F}_{2} ( i ) \qquad Formula 9.2$$

In this case, the respective symbols have the same meaning as the symbols in the other formulas described above, and K and λ may represent specific values set by the PID control algorithm. In this way, it is possible to combine the advantages of proportional control, integral control and differential control, thus determining the placement efficiency measures associated with respective predetermined probabilities in a more stable manner.

According to an example implementation of the present disclosure, the placement efficiency measures associated with respective predetermined probabilities may be determined using the formula described above. Further, the magnitude of each placement efficiency measure may be compared, and then the predicted value of the quantity of requisite resources for placement corresponding to a larger placement efficiency measure (e.g., higher profit) may be selected. In this case, where it is determined that a first placement efficiency measure of the plurality of placement efficiency measures is higher than a second placement efficiency measure, a first predicted value corresponding to the first placement efficiency measure may be selected from the predicted values of the quantity of requisite resources for a plurality of placements, that is, the predicted value corresponding to the higher profit may be selected.

Specifically, various placement efficiency measures corresponding to probabilities such as 5%, 10%, and 15% may be determined respectively. Respective placement efficiency measures may be compared, and the quantity of requisite resources for placement corresponding to the maximum placement efficiency measure may be selected. For example, the quantity B_{1,max} and B_{2,max} of requisite resources for placement corresponding to max [profit₁(i)] and max [profit₂ (i)] may be determined respectively, and further a final bid for the target media item may be determined.

According to an example implementation of the present disclosure, the above formulas 9.1 and 9.2 may be summed, a probability that the maximum placement efficiency measure may be obtained may be determined, and then the quantity of requisite resources for placement corresponding to the posterior distribution and the SSR data may be obtained, respectively.

According to an example implementation of the present disclosure, the predicted values of the quantity of requisite resources for a plurality of placements may be determined based on both the first network 510 and the second network 520. Specifically, the weights of the first network 510 and the second network 520 may be respectively determined based on the posterior distribution and the importance of the SSR data, and the predicted values of the quantity of requisite resources for a plurality of placements are determined based on the weighting of the first distribution and the second distribution. Assuming that the weights of the two networks are coefand (1−coef) respectively, the predicted value of the final quantity of requisite resources for placement associated with the plurality of predetermined probabilities may be determined based on the following formula:

$${B}_{final} = coef * {B}_{1 , max} + ( 1 - coef ) * {B}_{2 , max} \qquad Formula 10$$

In the above formula, B_{final} represents the quantity of requisite resources for placement as the final bid, B_{1,max} represents the quantity of requisite resources for placement determined based on the posterior distribution, and B_{2,max} represents the quantity of requisite resources for placement determined based on the SSR data. In this way, the posterior distribution of historical bidding can be comprehensively considered, and potential deviations of the second network 520 trained based on the true SSR data may be corrected using the posterior distribution. In this way, the accuracy of the prediction model 220 may be improved.

With the example implementations of the present disclosure, the quantity of requisite resources for placement at various probabilities may be predicted, and then the quantity of requisite resources for placement with higher placement efficiency measures may be selected as the bid. In this way, the placement efficiency of the media item can be improved, for example, the influence of the target media item can be broadened and more audiences can browse the placed media item, and so on. Further, the posterior distribution of the historical bidding data may be used to correct the problem that objective bidding information is not included in the SSR data, so that the prediction model 220 can provide a more accurate predicted value of the quantity of requisite resources for placement.

### Example Process

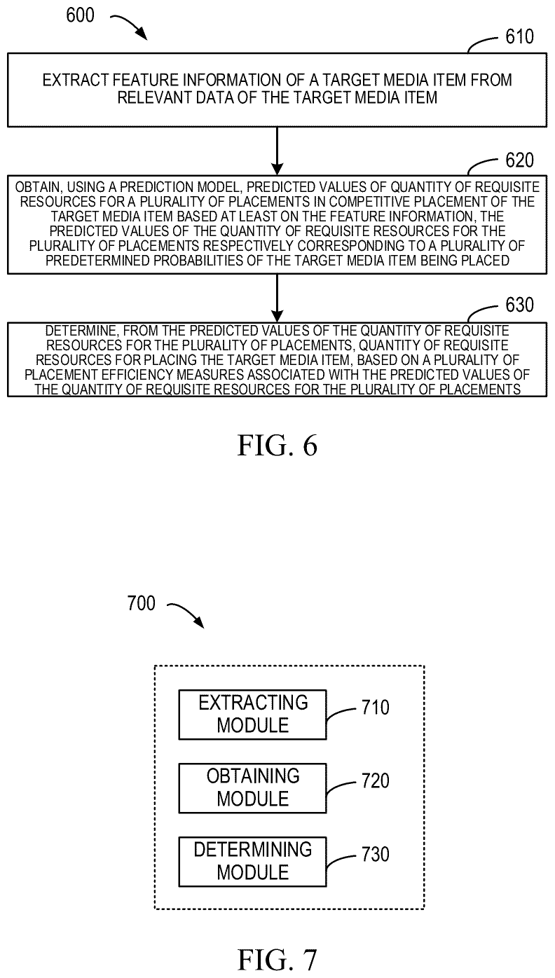

FIG. 6 illustrates a flowchart of a method 600 for determining quantity of requisite resources for placing a media item. At block 610, feature information of a target media item is extracted from relevant data of the target media item. At block 620, predicted values of quantity of requisite resources for a plurality of placements in competitive placement of the target media item are obtained using a prediction model based at least on the feature information, the predicted values of the quantity of requisite resources for the plurality of placements respectively corresponding to a plurality of predetermined probabilities of the target media item being placed. At block 630, quantity of requisite resources for placing the target media item is determined from the predicted values of the quantity of requisite resources for the plurality of placements, based on a plurality of placement efficiency measures associated with the predicted values of the quantity of requisite resources for the plurality of placements.

According to an example implementation of the present disclosure, obtaining the predicted values of the quantity of requisite resources for the plurality of placements comprises: determining, using the prediction model, a distribution of the quantity of requisite resources for a plurality of placements associated with the plurality of predetermined probabilities, based at least on the feature information; and determining the predicted values of the quantity of requisite resources for the plurality of placements based on the distribution of the quantity of requisite resources for the plurality of placements, respectively.

According to an example implementation of the present disclosure, the prediction model comprises a first network, the first network describing a first correlation between first reference quantity of requisite resources for placement in a first reference competitive placement of a first reference media item and first reference feature information of the first reference media item; and determining the distribution of the quantity of requisite resources for the plurality of placements associated with the plurality of predetermined probabilities comprises: determining, using the first network, a first distribution of the quantity of requisite resources for the plurality of placements associated with the plurality of predetermined probabilities.

According to an example implementation of the present disclosure, the prediction model comprises a second network, the second network describing a second correlation between a presentation of a second reference media item in a second reference competitive placement of the second reference media item and second reference feature information of the second reference media item; and determining the distribution of the quantity of requisite resources for the plurality of placements associated with the plurality of predetermined probabilities comprises: determining, using the second network, a second distribution of the quantity of requisite resources for the plurality of placements associated with the plurality of predetermined probabilities.

According to an example implementation of the present disclosure, obtaining the predicted values of the quantity of requisite resources for the plurality of placements comprises: determining the predicted values of the quantity of requisite resources for the plurality of placements based on the first distribution and the second distribution.

According to an example implementation of the present disclosure, the plurality of placement efficiency measures are determined based on the predicted values of the quantity of requisite resources for the plurality of placements, a value measure of the target media item, and the plurality of predetermined probabilities.

According to an example implementation of the present disclosure, the method further comprises:

adjusting the plurality of placement efficiency measures based on a proportional integral differential control parameter.

According to an example implementation of the present disclosure, a relationship between the predicted values of the quantity of requisite resources for the plurality of placements and the value measure of the target media item satisfies a predetermined constraint condition.

According to an example implementation of the present disclosure, the value measure of the target media item is determined based on quantity of requisite resources for placement of the target media item, a predicted value of a click through rate of the target media item, and a predicted value of a conversion rate of the target media item.

According to an example implementation of the present disclosure, determining the quantity of requisite resources for placement based on the plurality of placement efficiency measures comprises: in response to determining that a first placement efficiency measure among the plurality of placement efficiency measures is higher than a second placement efficiency measure, selecting a first predicted value corresponding to the first placement efficiency measure from the predicted values of the quantity of requisite resources for the plurality of placements.

According to an example implementation of the present disclosure, the feature information of the target media item comprises at least any of: a type of the target media item, a platform on which the target media item is to be placed, an operating system of a platform on which the target media item is to be placed, a client device of a platform on which the target media item is to be placed, and a region in which the target media item is to be placed.

### Example Apparatus and Device

FIG. 7 shows a block diagram of an apparatus 700 for determining quantity of requisite resources for placing a media item. The apparatus comprises: an extracting module 710 configured to extract feature information of a target media item from relevant data of the target media item; an obtaining module 720 configured to obtain, using a prediction model, predicted values of quantity of requisite resources for a plurality of placements in competitive placement of the target media item based at least on the feature information, the predicted values of the quantity of requisite resources for the plurality of placements respectively corresponding to a plurality of predetermined probabilities of the target media item being placed; and a determining module 730 configured to determine, from the predicted values of the quantity of requisite resources for the plurality of placements, quantity of requisite resources for placing the target media item, based on a plurality of placement efficiency measures associated with the predicted values of the quantity of requisite resources for the plurality of placements.

According to an example implementation of the present disclosure, the obtaining module comprises:

a distribution determining module configured to determine, using the prediction model, a distribution of the quantity of requisite resources for a plurality of placements associated with the plurality of predetermined probabilities, based at least on the feature information; and a predicted value obtaining module configured to determine the predicted values of the quantity of requisite resources for the plurality of placements based on the distribution of the quantity of requisite resources for the plurality of placements, respectively.

According to an example implementation of the present disclosure, the prediction model comprises a first network, the first network describing a first correlation between first reference quantity of requisite resources for placement in a first reference competitive placement of a first reference media item and first reference feature information of the first reference media item; and the distribution determining module is configured to: determine, using the first network, a first distribution of the quantity of requisite resources for the plurality of placements associated with the plurality of predetermined probabilities.

According to an example implementation of the present disclosure, the prediction model comprises a second network, the second network describing a second correlation between a presentation of a second reference media item in a second reference competitive placement of the second reference media item and second reference feature information of the second reference media item; and the distribution determining module is configured to: determine, using the second network, a second distribution of the quantity of requisite resources for the plurality of placements associated with the plurality of predetermined probabilities.

According to an example implementation of the present disclosure, the predicted value determining module is further configured to: determine the predicted values of the quantity of requisite resources for the plurality of placements based on the first distribution and the second distribution.

According to an example implementation of the present disclosure, the plurality of placement efficiency measures are determined based on the predicted values of the quantity of requisite resources for the plurality of placements, a value measure of the target media item, and the plurality of predetermined probabilities.

According to an example implementation of the present disclosure, the apparatus further comprises: adjusting the plurality of placement efficiency measures based on a proportional integral differential control parameter.

According to an example implementation of the present disclosure, a relationship between the predicted values of the quantity of requisite resources for the plurality of placements and the value measure of the target media item satisfies a predetermined constraint condition.

According to an example implementation of the present disclosure, the value measure of the target media item is determined based on quantity of requisite resources for placement of the target media item, a predicted value of a click through rate of the target media item, and a predicted value of a conversion rate of the target media item.

According to an example implementation of the present disclosure, the determining module comprises: a selecting module configured to, in response to determining that a first placement efficiency measure among the plurality of placement efficiency measures is higher than a second placement efficiency measure, select a first predicted value corresponding to the first placement efficiency measure from the predicted values of the quantity of requisite resources for the plurality of placements.

According to an example implementation of the present disclosure, the feature information of the target media item comprises at least any of: a type of the target media item, a platform on which the target media item is to be placed, an operating system of a platform on which the target media item is to be placed, a client device of a platform on which the target media item is to be placed, and a region in which the target media item is to be placed.

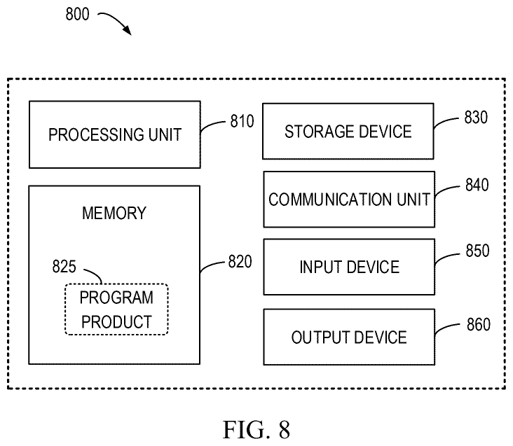

FIG. 8 illustrates a block diagram of a device 800 that can implement a plurality of implementations of the present disclosure. It should be understood that the computing device 800 shown in FIG. 8 is only illustrative and shall not constitute any limitation on the functions and scope of the implementations described herein. The computing device 800 shown in FIG. 8 can be used to implement the method described above.

As shown in FIG. 8, the computing device 800 is in the form of a general purpose computing device. Components of the computing device 800 may include, but are not limited to, one or more processors or processing units 810, a memory 820, a storage device 830, one or more communication units 840, one or more input devices 850, and one or more output devices 860. The processing unit 810 may be a physical or virtual processor and may execute various processing based on the programs stored in the memory 820. In a multi-processor system, a plurality of processing units executes computer-executable instructions in parallel to enhance parallel processing capability of the computing device 800.

The computing device 800 usually includes a plurality of computer storage mediums. Such mediums may be any attainable medium accessible by the computing device 800, including but not limited to, a volatile and non-volatile medium, a removable and non-removable medium. The memory 820 may be a volatile memory (e.g., a register, a cache, a Random Access Memory (RAM)), a non-volatile memory (such as, a Read-Only Memory (ROM), an Electrically Erasable Programmable Read-Only Memory (EEPROM), flash), or any combination thereof. The storage device 830 may be a removable or non-removable medium, and may include a machine-readable medium (e.g., a memory, a flash drive, a magnetic disk) or any other medium, which may be used for storing information and/or data (e.g., training data for training) and be accessed within the computing device 800.

The computing device 800 may further include additional removable/non-removable, volatile/non-volatile storage mediums. Although not shown in FIG. 8, there may be provided a disk drive for reading from or writing into a removable and non-volatile disk (e.g., “floppy disk”) and an optical disc drive for reading from or writing into a removable and non-volatile optical disc. In such cases, each drive may be connected to a bus (not shown) via one or more data medium interfaces. The memory 820 may include a computer program product 825 having one or more program modules, and these program modules are configured for performing various methods or acts of various implementations of the present disclosure.

The communication unit 840 implements communication with another computing device via a communication medium. Additionally, functions of components of the computing device 800 may be realized by a single computing cluster or a plurality of computing machines, and these computing machines may communicate through communication connections. Therefore, the computing device 800 may operate in a networked environment using a logic connection to one or more other servers, a Personal Computer (PC) or a further general network node.

The input device 850 may be one or more various input devices, such as a mouse, a keyboard, a trackball, a voice-input device, and the like. The output device 860 may be one or more output devices, e.g., a display, a loudspeaker, a printer, and so on. The computing device 800 may also communicate through the communication unit 840 with one or more external devices (not shown) as required, where the external device, e.g., a storage device, a display device, and so on, communicates with one or more devices that enable users to interact with the computing device 800, or with any device (such as a network card, a modem, and the like) that enable the computing device 800 to communicate with one or more other computing devices. Such communication may be executed via an Input/Output (I/O) interface (not shown).

According to the example implementations of the present disclosure, a computer-readable storage medium is provided, on which computer-executable instructions are stored, wherein the computer-executable instructions are executed by a processor to implement the method described above. According to the example implementations of the present disclosure, a computer program product is further provided, which is tangibly stored on a non-transient computer-readable medium and includes computer-executable instructions, which are executed by a processor to implement the method described above. According to the example implementations of the present disclosure, a computer program product is provided, storing a computer program thereon, the program, when executed by a processor, implementing the method described above.

Aspects of the present disclosure are described herein with reference to flowchart illustrations and/or block diagrams of methods, apparatus (systems), and computer program products according to implementations of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods and computer program products according to various implementations of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various implementations of the present disclosure have been presented for purposes of illustration, but are not intended to be exhaustive or limited to implementations disclosed. Many modifications and variations will be apparent to those of ordinary skill in the art without departing from the scope and spirit of the described implementations. The terminology used herein was chosen to best explain the principles of implementations, the practical application or technical improvement over technologies found in the marketplace, or to enable others of ordinary skill in the art to understand implementations disclosed herein.

I/We claim:

1. A method for determining quantity of requisite resources for placing a media item, comprising:
extracting feature information of a target media item from relevant data of the target media item;
obtaining, using a prediction model, predicted values of quantity of requisite resources for a plurality of placements in competitive placement of the target media item based at least on the feature information, the predicted values of the quantity of requisite resources for the plurality of placements respectively corresponding to a plurality of predetermined probabilities of the target media item being placed; and
determining, from the predicted values of the quantity of requisite resources for the plurality of placements, quantity of requisite resources for placing the target media item, based on a plurality of placement efficiency measures associated with the predicted values of the quantity of requisite resources for the plurality of placements.

2. The method of claim 1, wherein obtaining the predicted values of the quantity of requisite resources for the plurality of placements comprises:
determining, using the prediction model, a distribution of the quantity of requisite resources for a plurality of placements associated with the plurality of predetermined probabilities, based at least on the feature information; and
determining the predicted values of the quantity of requisite resources for the plurality of placements based on the distribution of the quantity of requisite resources for the plurality of placements, respectively.

3. The method of claim 2, wherein the prediction model comprises a first network, the first network describing a first correlation between first reference quantity of requisite resources for placement in a first reference competitive placement of a first reference media item and first reference feature information of the first reference media item; and
determining the distribution of the quantity of requisite resources for the plurality of placements associated with the plurality of predetermined probabilities comprises: determining, using the first network, a first distribution of the quantity of requisite resources for the plurality of placements associated with the plurality of predetermined probabilities.

4. The method of claim 3, wherein the prediction model comprises a second network, the second network describing a second correlation between a presentation of a second reference media item in a second reference competitive placement of the second reference media item and second reference feature information of the second reference media item; and
determining the distribution of the quantity of requisite resources for the plurality of placements associated with the plurality of predetermined probabilities comprises: determining, using the second network, a second distribution of the quantity of requisite resources for the plurality of placements associated with the plurality of predetermined probabilities.

5. The method of claim 4, wherein obtaining the predicted values of the quantity of requisite resources for the plurality of placements comprises: determining the predicted values of the quantity of requisite resources for the plurality of placements based on the first distribution and the second distribution.

6. The method of claim 1, wherein the plurality of placement efficiency measures are determined based on the predicted values of the quantity of requisite resources for the plurality of placements, a value measure of the target media item, and the plurality of predetermined probabilities.

7. The method of claim 6, further comprising: adjusting the plurality of placement efficiency measures based on a proportional integral differential control parameter.

8. The method of claim 6, wherein a relationship between the predicted values of the quantity of requisite resources for the plurality of placements and the value measure of the target media item satisfies a predetermined constraint condition.

9. The method of claim 1, wherein the value measure of the target media item is determined based on quantity of requisite resources for placement of the target media item, a predicted value of a click through rate of the target media item, and a predicted value of a conversion rate of the target media item.

10. The method of claim 1, wherein determining the quantity of requisite resources for placement based on the plurality of placement efficiency measures comprises: in response to determining that a first placement efficiency measure among the plurality of placement efficiency measures is higher than a second placement efficiency measure, selecting a first predicted value corresponding to the first placement efficiency measure from the predicted values of the quantity of requisite resources for the plurality of placements.

11. The method of claim 1, wherein the feature information of the target media item comprises at least any of: a type of the target media item, a platform on which the target media item is to be placed, an operating system of a platform on which the target media item is to be placed, a client device of a platform on which the target media item is to be placed, and a region in which the target media item is to be placed.

12. An electronic device, comprising:
at least one processing unit; and
at least one memory coupled to the at least one processing unit and storing instructions executable by the at least one processing unit, the instructions, when executed by the at least one processing unit, causing the electronic device to perform acts comprising:
extracting feature information of a target media item from relevant data of the target media item;
obtaining, using a prediction model, predicted values of quantity of requisite resources for a plurality of placements in competitive placement of the target media item based at least on the feature information, the predicted values of the quantity of requisite resources for the plurality of placements respectively corresponding to a plurality of predetermined probabilities of the target media item being placed; and
determining, from the predicted values of the quantity of requisite resources for the plurality of placements, quantity of requisite resources for placing the target media item, based on a plurality of placement efficiency measures associated with the predicted values of the quantity of requisite resources for the plurality of placements.

13. The electronic device of claim 12, wherein obtaining the predicted values of the quantity of requisite resources for the plurality of placements comprises:
determining, using the prediction model, a distribution of the quantity of requisite resources for a plurality of placements associated with the plurality of predetermined probabilities, based at least on the feature information; and
determining the predicted values of the quantity of requisite resources for the plurality of placements based on the distribution of the quantity of requisite resources for the plurality of placements, respectively.

14. The electronic device of claim 13, wherein the prediction model comprises a first network, the first network describing a first correlation between first reference quantity of requisite resources for placement in a first reference competitive placement of a first reference media item and first reference feature information of the first reference media item; and
determining the distribution of the quantity of requisite resources for the plurality of placements associated with the plurality of predetermined probabilities comprises: determining, using the first network, a first distribution of the quantity of requisite resources for the plurality of placements associated with the plurality of predetermined probabilities.

15. The electronic device of claim 14, wherein the prediction model comprises a second network, the second network describing a second correlation between a presentation of a second reference media item in a second reference competitive placement of the second reference media item and second reference feature information of the second reference media item; and
determining the distribution of the quantity of requisite resources for the plurality of placements associated with the plurality of predetermined probabilities comprises: determining, using the second network, a second distribution of the quantity of requisite resources for the plurality of placements associated with the plurality of predetermined probabilities.

16. The electronic device of claim 15, wherein obtaining the predicted values of the quantity of requisite resources for the plurality of placements comprises: determining the predicted values of the quantity of requisite resources for the plurality of placements based on the first distribution and the second distribution.

17. The electronic device of claim 12, wherein the plurality of placement efficiency measures are determined based on the predicted values of the quantity of requisite resources for the plurality of placements, a value measure of the target media item, and the plurality of predetermined probabilities.

18. The electronic device of claim 17, wherein the acts further comprise: adjusting the plurality of placement efficiency measures based on a proportional integral differential control parameter.

19. The electronic device of claim 17, wherein a relationship between the predicted values of the quantity of requisite resources for the plurality of placements and the value measure of the target media item satisfies a predetermined constraint condition.

20. A computer-readable storage medium having a computer program stored thereon, wherein the computer program, when executed by a processor, causes the processor to perform acts comprising:
extracting feature information of a target media item from relevant data of the target media item;
obtaining, using a prediction model, predicted values of quantity of requisite resources for a plurality of placements in competitive placement of the target media item based at least on the feature information, the predicted values of the quantity of requisite resources for the plurality of placements respectively corresponding to a plurality of predetermined probabilities of the target media item being placed; and
determining, from the predicted values of the quantity of requisite resources for the plurality of placements, quantity of requisite resources for placing the target media item, based on a plurality of placement efficiency measures associated with the predicted values of the quantity of requisite resources for the plurality of placements.
